(19) United States
(12) Patent Application Publication
(10) Pub. No.: US 2026/0236714 A1
(43) Pub. Date: Aug. 13, 2026

(54) SYSTEMS AND METHODS FOR SYNTHESIZING EQUIPMENT DATA

(71) Applicant: Schlumberger Technology Corporation, Sugar Land, TX (US)

(72) Inventors: Sai Shravani Sistla, Menlo Park, CA (US); Monisha Manoharan, Menlo Park, CA (US); Nasser Ghorbani, Houston, TX (US); Matthew Course, Houston, TX (US)

(21) Appl. No.: 19/051,699

(22) Filed: Feb. 12, 2025

(51) Int. Cl. G06F 40/40

(52) U.S. Cl. CPC G06F 40/40

(57) ABSTRACT

A computer-implemented method includes identifying a repository of equipment documents in an unstructured format for oil and gas equipment, generating text-based equipment documents in a computer-readable text format, and generating a vector index of vector embeddings from the text-based equipment documents. The method includes, in response to receiving an equipment content request, providing the vector index and an equipment content prompt to a generative AI model for instructing the generative AI model to generate an equipment content response using the vector embeddings from the vector index. Based on receiving the equipment content response from the generative AI model, the method includes providing the equipment content response to a client device.

### BACKGROUND

Information regarding equipment in the oil and gas industry may often be maintained in a repository or data storage in a variety of forms. It may be advantageous to discover and synthesize equipment information from a large and diverse data repository for performing various tasks in an efficient, complete, and effective manner.

### SUMMARY

In some embodiments, a computer-implemented method for generating equipment content responses using a generative artificial intelligence (AI) model, includes identifying a repository of equipment documents in an unstructured format for oil and gas equipment, generating text-based equipment documents based on parsing the equipment documents into a computer-readable text format, and generating a vector index of vector embeddings by using an embedding model to create the vector embeddings from the text-based equipment documents. The method includes, in response to receiving an equipment content request, providing the vector index and an equipment content prompt generated based on the equipment content request to a generative AI model, the equipment content prompt including instructions for the generative AI model to generate an equipment content response using the vector embeddings from the vector index, and based on receiving the equipment content response from the generative AI model, providing the equipment content response to a client device. In some embodiments, the method is performed by a computer system. In some embodiments, the method is performed as instructions stored on a computer-readable storage medium.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings.

FIG. 1A illustrates an example environment in which an equipment content system is implemented, according to at least one embodiment of the present disclosure.

FIG. 1B illustrates an example implementation of an equipment content system as described herein, according to at least one embodiment of the present disclosure.

FIGS. 2A to 2E illustrate various workflows of the equipment content system, according to at least one embodiment of the present disclosure.

FIG. 3 illustrates a flow diagram for a method or a series of acts for generating equipment content responses using a generative artificial intelligence (AI) model, according to at least one embodiment of the present disclosure.

FIG. 4 illustrates certain components that may be included within a computing system.

### DETAILED DESCRIPTION

This disclosure generally relates to systems and methods for utilizing generative artificial intelligence (AI) models to synthesize equipment data originating from a variety of unstructured sources. For instance, a computer-implemented equipment content system is described herein which may facilitate generating equipment content using a generative artificial intelligence (AI) model responsive to requests for equipment content. For example, equipment content may be generated responsive to a query, request, question, task, etc., related to oil and gas (e.g., wellbore and/or downhole) equipment, which may rely on discovering and/or synthesizing equipment information contained in a repository of equipment documents. In many cases, the repository may be large and may contain a considerable amount of equipment documents in a variety of different forms, including unstructured formats. The equipment content system may leverage generative AI models to discover equipment information relevant to a given request or query in the equipment documents and may synthesize this relevant equipment information to generate the equipment content. For example, equipment documents may be embedded and stored in a vector index, and the vector index may be provided to a generative AI model for generating equipment content based on the embedded equipment documents. Equipment content may be a design of an oil and gas system or subsystem, a plan or procedure for an oil and gas operation, a quote for providing an oil and gas service or product, or any other content related to oil and gas equipment.

The equipment content system may generate equipment content for providing equipment content responses in this way based on maintaining a vector index of an embedding space for the equipment documents in the data repository. For example, the equipment content system parses unstructured equipment documents and extracts text data, tabular data, and/or image data from the equipment documents in one or more computer-readable text formats. The equipment content system may then segment this computer-readable data and generate vector embeddings in a multi-dimensional embedding and/or vector space, which may be indexed into one or more vector indices and associated with corresponding metadata related to the underlying equipment documents. By doing so, the equipment content system embeds and correlates equipment information contained in the equipment documents into the vector index (or multiple indices) for quantifying and characterizing various aspects, qualities, contexts, etc., of the information in the equipment documents.

The equipment content system may accordingly be implemented to receive equipment content requests and generate equipment content responsive to the requests based on the equipment information in the equipment documents by using the vector index. For example, the equipment content system generates an equipment content prompt based on the equipment content request and provides the prompt, together with the vector index, to a generative AI model for responding to the prompt and/or request. The generative AI model may discover, utilize, and/or access one or more of the vector embeddings based on the vector index and may generate equipment content that may be a synthesis, combination, and/or synergy of equipment information relevant to the equipment content request. For instance, in some cases, the equipment content requests or queries for a design, quote, information, etc., that is not specifically found in any of the equipment documents, and the generative AI model accordingly generates new content based on combining and/or synthesizing related equipment information from the equipment documents. In this way, the equipment content system may facilitate generating equipment content based on a vast store of equipment documents having a variety of formats in an efficient, accurate, and complete manner.

As will be discussed in further detail below, the present disclosure includes a number of technical benefits and practical applications described herein that solve problems associated with discovering and synthesizing equipment information from numerous unstructured equipment documents using embedding models and generative AI models. Some example benefits are discussed herein in connection with various features and functionalities provided by an equipment content system implemented on one or more computing devices. Benefits explicitly discussed in connection with one or more embodiments described herein are provided by way of example and are not intended to be an exhaustive list of all possible benefits of the equipment content system.

To elaborate, while generative AI models are implemented for performing a wide variety of tasks, they are, however, faced with practical limits related to token limits, which may limit the amount of input information that generative AI models can take in. Accordingly, token limits can significantly limit the usefulness of generative AI models for being implemented in connection with large data stores of information, such as the repository of equipment documents as described herein. For example, due to these token limits, it may not be practical or even possible to directly provide a large number of equipment documents to a generative AI model and query the model with respect to these equipment documents.

The equipment content system described herein, however, may be advantageously implemented notwithstanding token limits in order to make requests of generative AI models with respect to a considerable (e.g., most or all) repository of equipment documents by pre-processing and/or pre-embedding the equipment information of the equipment documents, and providing this pre-embedded information to the generative AI models as the vector index. Thus, a generative AI model may be given a specific prompt or request and may reference and/or traverse the embedding space of the vector index representative of a large data repository in order to generate equipment content responsive to the prompt. Furthermore, the equipment content system described herein facilitates discovering and synthesizing information from a considerable amount of sources with a generative AI model that would otherwise not be feasible due to token limits.

The equipment content system also provides valuable flexibility benefits for performing tasks and generating content with respect to the repository of equipment documents. For example, some conventional solutions that directly provide equipment documents to a generative AI model as input data to generate equipment content may require larger, more sophisticated, and/or more robust generative AI models, such as those having higher token limits. In contrast, because the equipment content system may circumvent conventional challenges associated with token limits in the advantageous way described herein, equipment content may be generated by generative AI models, for example, that are smaller, less complex, and/or more economical than would otherwise be the case, providing flexibility of implementing such a system. For instance, the equipment content system and/or the associated generative AI model(s) may be implemented on local and/or offline computing devices, for example, without being limited to sophisticated, robust, and/or specialized computing resources and/or cloud computing systems.

Additionally, by generating the vector embeddings and vector index based on parsing and extracting information from the equipment documents, the equipment content system provides further adaptability to a wide variety of document formats, includes unstructured formats. In this way, the equipment content system may be implemented in connection with a number of different subject matter domains and with respect to data repositories having a number of different forms of data stored therein.

Further, the equipment content system pre-processes and/or pre-embeds the equipment information of the equipment documents for providing to a generative AI model in such a way that the underlying information is not lost to the generative AI model despite the equipment documents not being directly provided as input to the generative AI model. For instance, metadata is associated with each vector embedding corresponding to the underlying equipment documents, providing redundancy of information. In some cases, the metadata includes the underlying equipment information (e.g., text) or else refers back to an underlying equipment document where the equipment information can be found. In this way, the generative AI model may refer to this redundant information in order to resolve discrepancies, verify information, or otherwise supplement the performance of its task.

Additional details will now be provided regarding systems described herein in relation to illustrative figures portraying example implementations of an equipment content system. For instance, various illustrative figures are shown and described herein related to various workflows of the equipment content system for utilizing generative AI models to synthesize equipment information to generate equipment content based on embeddings of unstructured equipment documents.

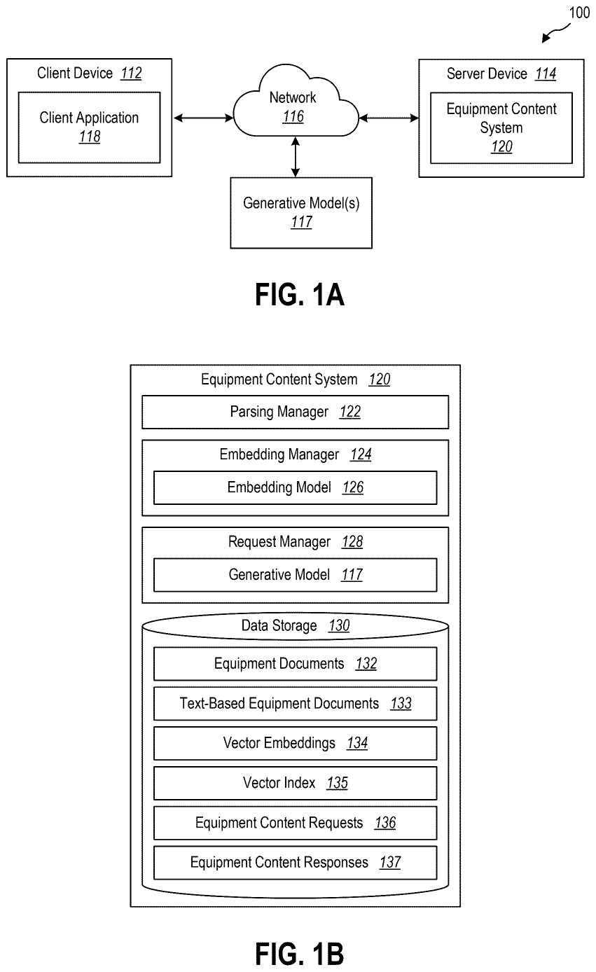

FIG. 1A illustrates an example environment 100 in which an equipment content system 120 is implemented in accordance with one or more embodiments described herein. As shown in FIG. 1A, the environment 100 includes a server device 114. The server device 114 may include one or more computing devices (e.g., processing units, data storage, etc.) organized in an architecture with various network interfaces for connecting to and providing data management and distribution across one or more client systems. As shown in FIG. 1A, the server device 114 may be connected to and may communicate with (either directly or indirectly) a client device 112 through a network 116. The network 116 may include one or multiple networks and may use one or more communication platforms and/or technologies suitable for transmitting data. The network 116 may refer to any data link that enables the transportation of electronic data between devices of the environment 100. The network 116 may refer to a hardwired network, a wireless network, or a combination of a hardwired network and a wireless network. In one or more embodiments, the network 116 includes the internet.

The client device 112 may be representative of one or multiple client devices, and may refer to various types of computing devices. For example, the client device 112 may include a mobile device such as a mobile telephone, a smartphone, a personal digital assistant (PDA), a tablet, a laptop, or any other portable device. Additionally, or alternatively, the client device 112 may include one or more non-mobile devices such as a desktop computer, server device, processor or computer, or other non-portable device. In one or more implementations, the client device 112 includes a graphical user interface (GUI) thereon (e.g., a screen of a mobile device). In addition, one or more of the client device 112 may be communicatively coupled (e.g., wired or wirelessly) to a display device having a graphical user interface thereon for providing a display of system content.

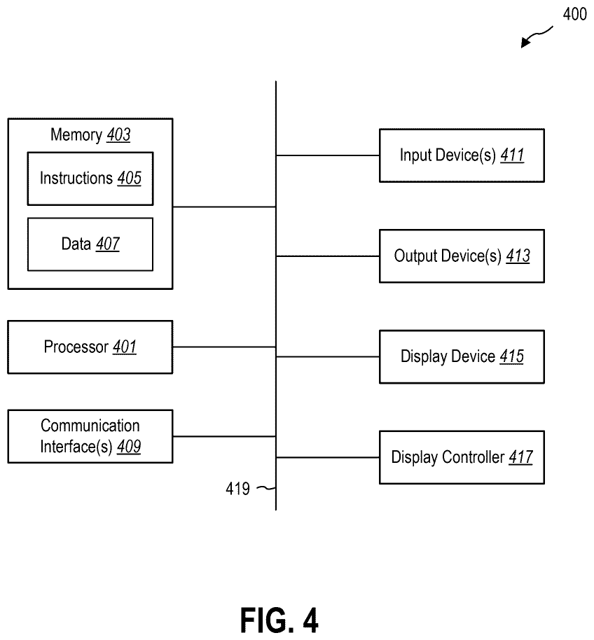

The server device 114 may similarly refer to various types of computing devices. For instance, the server device 114 may be representative of computing components and/or a computing system configured to execute and manage software components of the equipment content system 120. For example, the server device 114 may facilitate processing, storage, and/or distribution of data necessary for the operation of one or more features of the equipment content system 120. Each of the devices of the environment 100, such as the server device 114 and/or the client device 112 may include features and/or functionalities described below in connection with FIG. 4.

As shown in FIG. 1A, the environment 100 may include an equipment content system 120. While shown on the server device 114, the equipment content system 120 may be implemented wholly or in part on the client device 112, across the server device 114 and the client device 112, or on or across one or more additional devices, such that different portions or components of the equipment content system 120 are implemented on different computing devices in the environment 100. The client device 112 may include a client application 118. In some embodiments, one or more of the functionalities or features of the equipment content system 120 may be carried out or performed on or by a client application 118. The client application 118 may include an application or interface for interacting with and/or receiving the features of the equipment content system 120 as described herein. In some cases, the equipment content system 120 may be implemented across one or more devices.

The environment 100 may include a generative AI model 117. In some embodiments, the generative AI model 117 can be representative of one or more generative AI models. The generative models 117 may be accessible to the equipment content system 120 via the network 116. In some cases, the generative models 117 are implemented on or as part of the equipment content system 120, such as being stored or operated on the server device 114.

As used herein, the terms “generative artificial intelligence model,” “generative AI model,” and “generative model” are used interchangeably and refer to a large or small artificial intelligence system that utilizes deep learning and a large number of parameters (e.g., in the billions or trillions for a large version and fewer for a small version) to generate natural-language based outputs. In many implementations, a generative AI model is trained on one or more extensive datasets to produce coherent, contextually relevant, and fluently topic-specific outputs (e.g., text, graphs, charts, images, and/or other visual content). In many instances, a generative AI model refers to an advanced computational system that uses natural language processing, machine learning, and/or image processing to generate coherent and contextually relevant human-like responses.

Generative AI models have applications in natural language understanding, content generation, text summarization, dialog systems, language translation, creative writing assistance, image generation, audio generation, and more. A single generative AI model often performs a wide range of tasks by receiving different inputs, such as prompts (e.g., input instructions, rules, example inputs, example outputs, and/or tasks), data, and/or access to data. In response, the generative AI model generates various output formats ranging from one-word answers to long narratives, images and videos, labeled datasets, documents, tables, and presentations.

Moreover, generative AI models may primarily be based on transformer architectures to understand, generate, and manipulate human language. Generative AI models can also use other types of architectures such as recurrent neural network (RNN) architecture, long short-term memory (LSTM) model architecture, convolutional neural network (CNN) architecture, or other types of architectures. Examples of generative AI models include generative pre-trained transformer (GPT) models such as GPT-3.5, GPT-4, GPT-4o (including Sora), bidirectional encoder representations from transformers (BERT) model, text-to-text transfer transformer models like T5, conditional transformer language (CTRL) models, and Turing-NLG. Other types of generative AI models include sequence-to-sequence models (Seq2Seq), vanilla RNNs, and LSTM networks. In some instances, a generative AI model includes a large language model (LLM), which serves as a text-based version of a generative AI model, such as a generative AI model that receives text prompts and/or generates text outputs. In various implementations, a generative AI model is a multimodal generative model that receives multiple input formats (e.g., text, tables, images, video, data structures) and/or generates multiple output formats.

In some cases, as described herein, generative AI models may operate in response to “prompts,” “model prompts,” or “generative AI model prompts,” which refer to a request provided to a generative AI model to create a generative AI model output. For example, as described herein, an equipment content prompt includes instructions for a generative model to generate equipment content. In some cases, a prompt may be a plain language guidance prompt. In some instances, the equipment content system 120 provides additional information with a prompt, such as a vector index of vector embeddings as described herein. A prompt can include a user-level prompt that includes a user request or query, and/or can include a system-level or meta-level prompt that provides important contextual information and/or general framing information to ensure that the generative AI model understands the correct context, syntax, and grounding information of the data it is processing.

FIG. 1B illustrates an example implementation of the equipment content system 120 as described herein, according to at least one embodiment of the present disclosure. The equipment content system 120 includes a variety of components for synthesizing equipment data originating from a variety of unstructured sources. To illustrate, the equipment content system 120 includes a parsing manager 122, which may facilitate parsing and/or extracting equipment information from unstructured equipment documents into a computer-readable text format. The equipment content system 120 includes an embedding manager 124, which facilitates generating vector embeddings of the extracted equipment information for indexing via a vector index. For example, the embedding manager may include and/or interface with an embedding model 126, which may facilitate representing the extracted equipment information in a high-dimensional vector space.

The equipment content system 120 includes a request manager 128, which may be tasked with fielding and responding to requests of the system to create equipment content. For example, the request manager 128 may include and/or interface with the generative model 117, which may be included in the equipment content system 120 or located on another device or set of devices. The request manager 128 may administer various features of the generative model 117 for generating equipment content.

The equipment content system 120 may also include a data storage 130 having various data stored thereon. For example, the parsing manager 122 may access equipment documents 132 from the data storage 130 and may generate and store text-based equipment documents 133 on the data storage 130. In some embodiments, the equipment documents 132 are stored and/or maintained on the data storage 130 by the equipment contented system 120, or else the equipment documents 132 may be stored on another system and/or storage to which the equipment content system 120 has access. The embedding manager 124 may generate, from the text-based equipment documents, vector embeddings 134 which may be indexed via a vector index 135 (or multiple vector indices 135). The request manager 128 may receive and/or access equipment content requests 136 and may provide corresponding equipment content responses 137.

While one or more embodiments described herein describe features and functionalities performed by specific components 122-128 of the equipment content system 120, it will be appreciated that specific features described in connection with one component of the equipment content system 120 may, in some examples, be performed by one or more of the other components of the equipment content system 120. By way of example, one or more extractions or parsing features of the parsing manager 122 as described herein may be delegated to other components of the equipment content system 120. As another example, while vector embeddings may be generated and indexed by the embedding manager 124 as described herein, in some instances, some or all of these features may be performed by another component of the equipment content system 120. Indeed, it will be appreciated that some or all of the specific components may be combined into other components and specific functions may be performed by one or across multiple components 122-128 of the equipment content system 120.

Additionally, while FIG. 1B, for example, depicts the equipment content system 120 implemented on a client device 112, it should be understood that some or all of the features and functionalities of the equipment content system 120 may be implemented on or across multiple client devices 112 and/or server devices 114. For example, one or more equipment documents 132 may be accessed, and/or parsed by the parsing manager 122 on a (e.g., local) client device, and equipment content may be generated by the generative model 117 for providing via equipment content responses 137, for example, on one or more of a remote, server, or cloud device. Indeed, it will be appreciated that some or all of the specific components 122-128 may be implemented on or across multiple client devices 112 and/or server devices 114, including individual functions of a specific component being performed across multiple devices.

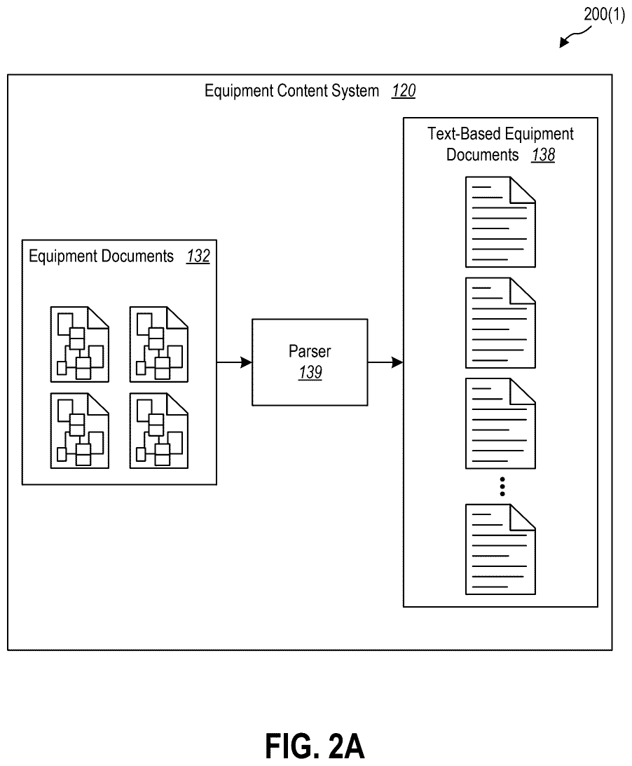

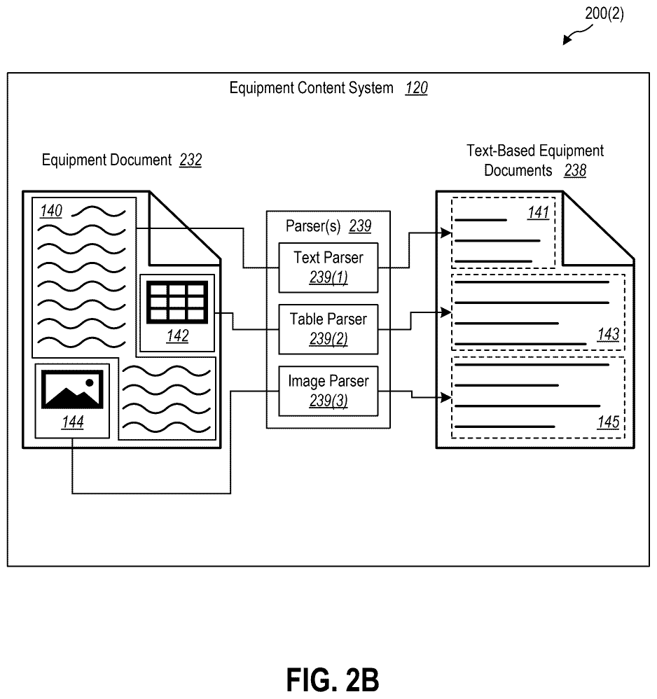

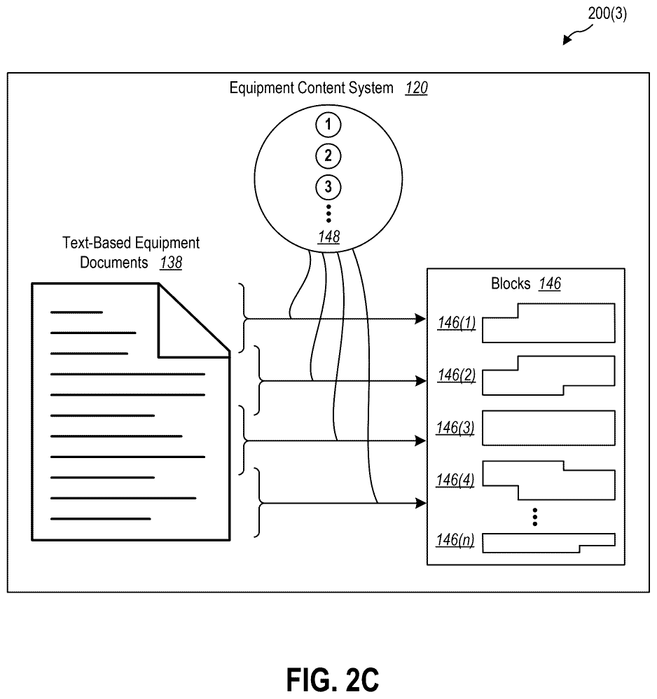

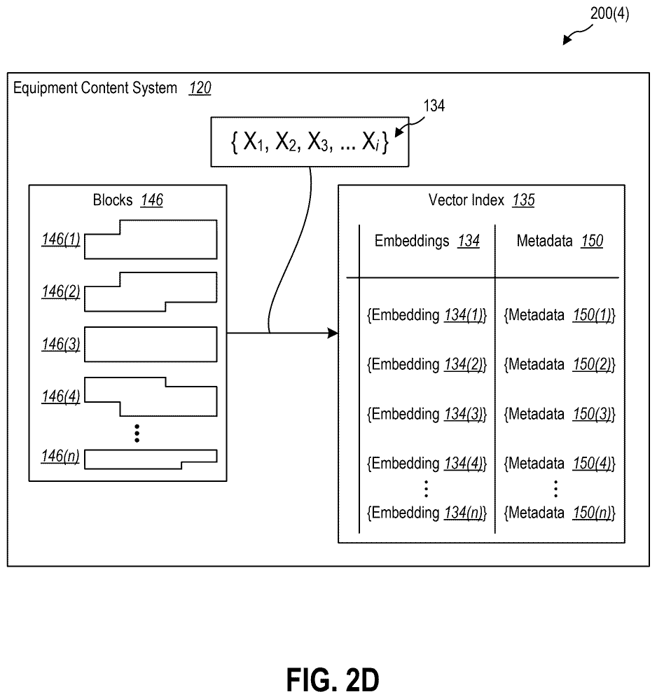

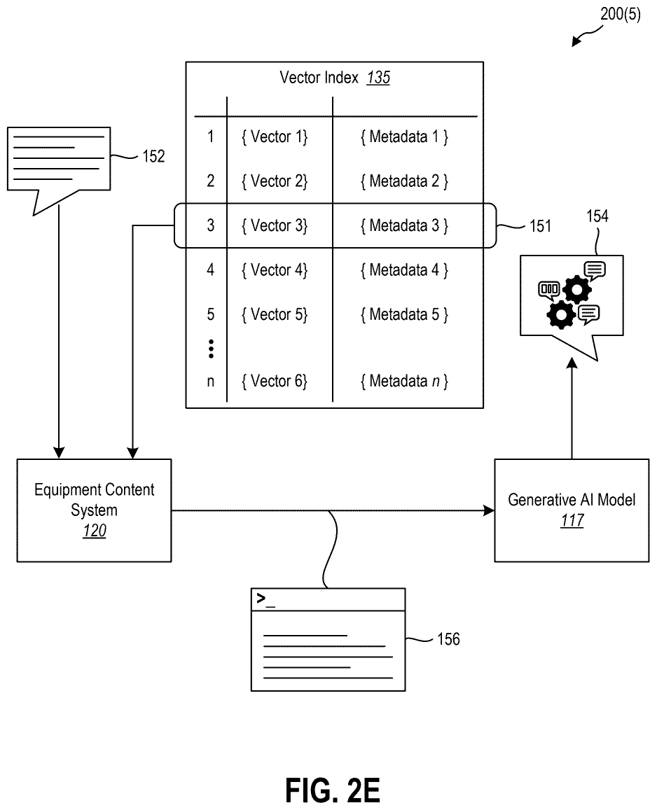

FIGS. 2A through 2E illustrate various workflows 200(1), 200(2), 200(3), 200(4), and 200(5) of the equipment content system 120, according to at least one embodiment of the present disclosure. One or more of the workflows 200(1) to 200(5) may be performed individually, or some or all of the workflows 200(1) to 200(5) may be performed in connection as part of a larger workflow of the equipment content system 120.

With reference to FIG. 2A, the equipment content system 120 may access the data storage 130 and, in particular, may access the equipment documents 132 stored thereon. The data storage 130 may be a library, data store, database, collection of files, repository, or other source of the equipment documents 132, which may be accessible to the equipment content system 120.

The equipment documents 132 may be any file, document, data, or object, which may include equipment information associated with oil and gas equipment. For example, the equipment documents 132 include equipment information such as types and/or specifications of oil and gas equipment, pricing and/or quotes for oil and gas equipment, operations and/or procedures for utilizing oil and gas equipment, or any other type of data relevant to oil and gas equipment. The equipment documents 132 may contain the equipment information in any number of different forms. For example, the equipment documents 132 may include reports, logs, plans, specifications, manuals, brochures, quotes, bids, designs, bills of materials, procedures, charts, measurement data, or any other document, form, format, or file type that may include the equipment information.

In some cases, the equipment documents 132 may be in an unstructured format. For instance, the equipment documents 132 may not be organized according to any predetermined data model, form, or schema, such that the equipment documents 132 may not be readily consumed, processed, or evaluated by a computing system. For example, some of the equipment documents 132 may not include predetermined or structured fields containing data in a specific location, structure, or format for input into one or more computing applications. In some instances, the equipment documents 132 are stored in an unstructured image format. For instance, some of the equipment documents 132 may not be in a computer-readable text format, such as a JavaScript Object Notation (JSON) or Extensible Markup Language (XML) format. In some cases, the equipment documents 132 include PDF documents containing equipment information that is not in a typical computer-readable format and/or that is not readily readable by a computing system.

In some cases, the equipment documents may be unstructured in that they include unstructured content (e.g., text, tables, images) that are not readily readable by a computer application and/or are not contained in fields, schema, or other designated forms for being readily received by a computer application. In some embodiments, the equipment documents are unstructured in that they include unstructured text, such as freeform text. In some embodiments, the equipment documents are unstructured in that they include unstructured tables, such as information contained in a table-like presentation that is not a tabular object or format. in some embodiments, the equipment documents 132 are unstructured in that they include images. For example, the equipment documents 132 may include unstructured content via PDF documents, image documents. In this way, the equipment documents 132 may be unstructured and may include equipment information in a variety of different forms.

In some embodiments, the equipment content system 120 generates text-based equipment documents 138 from the equipment documents 132, as described below. For example, the equipment content system 120 may employ a parser 139 for generating the text-based equipment document 138 based on the equipment documents 132. The equipment content system 120 may generate the text-based equipment documents 138 as textualized or text-based versions of the equipment documents 132. For example, the text-based equipment documents 138 may be (or may include the underlying equipment information of) the equipment documents 132 in a computer-readable text format such as a JSON format. The computer-readable text format may be one or more formats that a computing system or application may readily process or consume in order to obtain or access the underlying equipment information. For example, a computer-readable text format includes extracted text from a source of unstructured text. In another example, a computer-readable text format includes text relaying (and/or summarizing) information from a source of unstructured tables. In some cases, a computer-readable text format includes text describing or summarizing an image.

The equipment content system 120 may generate the text-based equipment documents 138 based on parsing the equipment documents 132. For example, the equipment content system 120 may utilize a parsing tool, model, or other component to analyze the equipment information in the unstructured form of the equipment documents 132, and may extract, parse, or otherwise convert the equipment information into the computer-readable text format(s) of the text-based equipment documents 138. The equipment content system 120 may generate a text-based equipment document 138 for each equipment document 132, generate multiple text-based equipment documents 138 for each equipment document, and/or generate a text-based equipment document 138 for multiple equipment documents 132. In this way, the equipment content system 120 may convert the unstructured nature of the equipment documents 132 into a computer-readable structure to facilitate the features and functionalities as described herein.

The workflow 200(2) of FIG. 2B illustrates an example of generating a text-based equipment document 238 based on an equipment document 232. In some cases, the workflow 200(2) may be performed by the parsing manager 122 of the equipment content system 120.

As mentioned above, in some cases the equipment document 232 include unstructured text 140, unstructured tables 142, and/or images 144. The equipment content system 120 may process, evaluate, and/or extract the unstructured text 140, the unstructured tables 142, and the images 144 separately, and may generate textualized data of the same. For instance, the equipment content system 120 may employ a parser 239 (e.g., or multiple parsers 239) for generating the text-based equipment document 238 based on the equipment document 232. The parser(s) 239 may include parsing tool, a machine learning model such as a generative AI model or large language model (LLM), or another component for generating the textualized data. This textualized data may be stored in separate portions of the text-based equipment document 238, or else in separate text-based equipment documents. For instance, the text-based equipment document 238 may be a JSON file having separate portions or sections for text, tables, and images.

In some embodiments, the equipment content system 120 parses or extracts the unstructured text 140 and generates text data 141. For example, the parser(s) 239 may include a text parser 239(1) configured to parse and/or extract unstructured text. The text data 141 may be a copy or a textual description of the unstructured text 140. For example, the equipment content system 120 may parse the equipment document 232 and may generate computer-readable text that relates the equipment information of the unstructured text 140, such as word-for-word, as a summary, or a textual description of the unstructured text 140.

In some embodiments, the equipment content system 120 parses or extracts the unstructured tables 142 and generates tabular data 143. For example, the parser(s) 239 may include a table parser 239(2) configured to extract tabular information from unstructured tables. The tabular data 143 may be a text-based representation of the unstructured table 142, for example in a JSON (or other suitable) format in the text-based equipment document 138. For example, the equipment content system 120 may parse the equipment document 232 and may convert the equipment information contained in the unstructured tables 142, as well as the structure (e.g., rows, columns, labels, etc.) of the unstructured tables into columnar text in the text-based equipment document 238.

In some embodiments, the equipment content system 120 generates the tabular data 143 as text that may describe, summarize, and/or synthesize equipment information of the unstructured tables 142. For example, the equipment content system 120 may implement a generative AI model (e.g., an LLM) that may analyze the unstructured table 142 and may generate a textual description of the table as the tabular data 143. This textual description may be in addition to, or else as an alternative to, parsing the actual data from the unstructured tables 142 as described.

In some embodiments, the equipment content system 120 generates image data 145 based on the images 144. For example, the parser(s) 239 may include an image parser 239(3) configured to extract and/or interpret information from images. For example, the equipment content system 120 may generate an image description that may describe the contents of the image, explain a meaning or significance of the image, or describe the relation of the image to surrounding unstructured text 140 and/or unstructured tables 142, etc. The equipment content system 120 may generate the image data 145 based on a generative AI model.

In this way, the equipment content system 120 may generate text data 141, tabular data 143, and image data 145 from the unstructured text 140, unstructured tables 142, and images 144, respectively, of the equipment document 232. The equipment content system 120 may utilize the same tool, parser, or application (e.g., a multi-modal tool) for generating each of the text data 141, the tabular data 143, and the image data 145 as described herein, or may implement multiple different tools for the various types of information in the equipment documents 132. The equipment content system 120 may operate in this way with respect to each of the equipment documents 132 for generating the text-based equipment document 138 as shown in FIG. 2A.

The workflow 200(3) of FIG. 2C illustrates an example of generating blocks 146 from the text-based equipment documents 138 for use in embedding into a multi-dimensional embedding or vector space. In some cases, the workflow 200(3) may be performed by the parsing manager 122 of the equipment content system 120.

After generating the text-based equipment documents 138, the equipment content system 120 may segment the text of the text-based equipment documents 138 and generate blocks 146. For instance, the equipment content system 120 may segment the text-based equipment documents 138 based on a specific number of words, sentences, paragraphs, sections, pages, topics, or other segmenting criteria. For instance, the blocks 146 (i.e., a first block 146(1), a second block 146(2), a third block 146(3), a fourth block 146(4), an nth block 146(n)) may be generated to include a specific number of words, paragraphs or until a specific size of data is met. In some implementations, the blocks are generated based on a word allocation, paragraph allocation, or other allocation.

In some embodiments, the equipment content system 120 may tokenize the text-based equipment documents 138 by generating and/or associating tokens 148 from or with the text-based equipment documents 138. For instance, the equipment content system 120 may convert or otherwise represent one or more words of the text-based equipment documents 138 with the tokens 148 (e.g., Token 1, Token 2, Token 3). In some cases, the equipment content system 120 may generate the blocks 146 based on a token allocation of a certain quantity of tokens per block 146.

In some embodiments, the blocks 146 may be generated having an overlap between adjacent or consecutive blocks 146. For example, the equipment content system 120 may generate the blocks 146 based on overlapping a certain amount of words, paragraphs, tokens, etc., from one block to a next block. Indeed, the blocks 146 may be generated having a token overlap. As an example, a first block may be generated based on an allocation of tokens 148 (or words, paragraphs, etc.) from 1 to 100, and a second block may be generated based on an allocation of tokens 148 (or words, paragraphs, etc.) from 80 to 180, and so on. In this way, each block may include overlapping information from a previous block and a subsequent block. This overlap may create continuity between consecutive blocks by preserving equipment information context, meaning, background, and/or perspective, especially or blocks 146 originating from the same equipment document but which may span several blocks.

Indeed, the blocks 146 may represent small excerpts, sections, chunks, or segments of the equipment information of the equipment documents 132, which may be utilized for embedding segments of the equipment information into an embedding space. The equipment content system 120 may generate any number of blocks 146, as shown in FIG. 2C by blocks 146(1) through 14(n). For instance, in some cases, a text-based equipment document 138 may be segmented as described herein for generating multiple blocks 146. In some embodiments, multiple text-based equipment documents 138 may be combined and represented in a singular block 146. The equipment content system 120 may generate blocks 146 for representing the equipment information in the body of equipment documents 132 based on segmenting each of the text-based equipment documents 138.

The workflow 200(4) of FIG. 2D illustrates an example of generating vector embeddings 134 from the blocks 146 to form a vector index 135. In some cases, the workflow 200(4) is performed by the embedding manager 124 and/or by utilizing the embedding model 126.

After generating the blocks 146, the equipment content system 120 may generate vector embeddings 134 based on embedding the blocks 146. For example, the equipment content system 120 may convert the (e.g., textual) data of each block 146 into a high-dimensional numerical representation by mapping the block 146 to a fixed-length vector embedding 134 in a continuous vector space or embedding space. The vector embeddings 134 may capture semantic relationships, contextual information, etc., from the text of the blocks 146, and represent this information as a set of values corresponding to various qualitative dimensions in a vector form. For example, the equipment content system 120 identifies and/or maps the content of each block 146 with values x₁ through xᵢ for dimensions 1 through i, and stores this mapping as a vector embedding 134. In this way, the blocks 146 may be represented in a vector form and mapped to a high-dimensional embedding space for enabling computational processing and similarity (e.g., vector distance) measurements between vector embeddings 134 in the embedding space. The equipment content system 120 may generate a vector embedding 134 for each block 146 and in this way may relate some or all of the equipment information contained in the equipment documents via vector representations mapped to the embedding space.

The equipment content system 120 may store each of the vector embeddings 134 in a vector index 135. For example, the vector index 135 may be an index of each of the vector embeddings 134 corresponding with each of the underlying blocks 146, represented in FIG. 2D as vector embeddings 134(1) through 134(n). For instance, the vector index 135 may be a table or other object, which may store or reference the vector embeddings 134. In some instances, the vector index 135 is a stored version of the embedding space that includes the vector embeddings 134.

In some embodiments, the vector index 135 may define and/or may include information detailing the mapping of the embedding space. For example, the vector index 135 may define the various dimensions of the embedding space, their meaning or context, etc., which may facilitate providing the vector index 135 to a generative AI model to perform inferencing and/or generate content based on the vector index 135.

In some embodiments, the equipment content system 120 may generate metadata 150, and may store or otherwise associate the metadata 150 with the vector embeddings 134 in the vector index 135. For example, the equipment content system 120 may generate metadata 150(1) through 150(n) for each block 146, which may correspond to context and/or background information for the underlying equipment information from which the blocks 146 are derived. For example, each block 146 may correspond to a section of text, one or more tables, and/or one or more images originating from an equipment document, and the metadata 150 may identify a document location of the equipment document from which it originates. The metadata 150 may provide a link or reference to the corresponding equipment document. In another example, the metadata 150 may indicate text, context, meaning, significance, background, etc. for a block based on the text, table(s), and/or image(s) that are located surrounding, adjacent, or near the associated content in the underlying equipment document. In various cases, the metadata 150 may include the text, table(s), and/or image(s) corresponding to a block 146 (e.g., in an original or textualized/parsed form), such as a reference to provide redundancy of information, to validate the vector embedding 134, etc.

In some cases, the equipment content system 120 generates one vector index 135. For example, blocks derived from any of unstructured text, unstructured tables, and/or images may be embedded into the same embedding space and stored in the same vector index 135.

In some cases, the equipment content system 120 generates multiple vector indices 135. For example, the equipment content system 120 may embed blocks 146 derived from unstructured text, unstructured tables, and images into separate embedding spaces for text, tables, and images, respectively, and may store the vector embeddings 134 into respective vector indices for text, tables, and images. In this way, the equipment content system 120 may generate the vector embeddings 134 and one or more vector indices 135 as part of a pre-processing or pre-embedding operation to facilitate utilizing a generative AI model to generate equipment content based on the equipment information in the equipment documents 132.

The workflow 200(5) illustrates an example of generating an equipment content response 154 with a generative AI model 117 responsive to an equipment content request 152. In some embodiments, the workflow 200(5) is performed by the request manager 128 in connection with the generative AI model 117.

In some cases, the equipment content system 120 receives an equipment content request 152. For example, the equipment content request 152 may be provided by a client device associated with user, such as in a text-based query. The equipment content request 152 may be associated with creating equipment content based on the equipment information and the equipment documents 132. For example, the equipment content request 152 may request a bid or quote for an oil and gas system, product, or service (e.g., a collection of several pieces of equipment). In some cases, the equipment content request 152 may inquire about information associated with one or more pieces of oil and gas equipment, such as specifications, operating instructions, designs, planned operations, etc. In various instances, the equipment content request 152 may be associated with generating a design of an oil and gas system, product, operation, process, or service, for example, based on types and specifications of oil and gas equipment detailed in the equipment documents 132.

Based on the equipment content request 152, the equipment content system 120 may generate an equipment content prompt 156. The equipment content prompt 156 may include an input query with instructions that guide the generative AI model 117 to produce a relevant, context-specific output. For example, the equipment content prompt 156 may include a system prompt having instructions, context, questions, constraints, examples, formatting guidelines, etc., that instruct the generative AI model 117 how to generate and/or structure an equipment content response.

In some cases, the equipment content system 120 generates the equipment content prompt 156 by utilizing the vector index 135 in connection with the equipment content request 152. For example, the equipment content system 120 may apply the vector index 135 to the equipment content request 152. In some cases, the equipment content system 120 uses the equipment content request 152 to identify relevant vector data within the vector index 135 (e.g., extracted vector data 151). For example, relevant vector data is extracted from the vector index that corresponds to the context of the equipment content request 152. The extracted vector data 151 is provided to the equipment content system 120 which can generate an equipment content prompt 156 (or a final prompt) from the extracted vector data 151 and the equipment content request 152.

The equipment content system 120 may then provide the equipment content prompt 156 to the generative AI model 117. Based on the equipment content prompt 156, the generative AI model 117 may generate an equipment content response 154. The equipment content response 154 may include equipment content generated by the generative AI model 117. For example, the generated equipment content may indicate information responsive to a query for information. In another example, the generated equipment content may include a design of an oil and gas system, product, process, operation, etc. as generated by the generative AI model 117. In another example, the generated equipment content may include a bid or quote for providing (e.g., a collection of) oil and gas equipment, such as a quote for providing an oil and gas system and/or service.

The generative AI model 117 may generate the equipment content response 154 based on one or more of the vector embeddings 134 (e.g., the extracted vector data 151) indicated in the vector index 135. For example, the generative AI model 117 may tokenize and/or embed the equipment content prompt 156 into the same or similar embedding space as the vector index 135. In addition, the generative AI model 117 may identify one or more vector embeddings 134 (the extracted vector data 151) that are similar, close to, and/or relevant to the (e.g., embedded) equipment content prompt 156 to generate the equipment content response 154. In some embodiments, the generative AI model 117 may access the full vector index 135 and/or refer to the metadata 150 for one or more vector embeddings 134 to clarify missing information or discrepancies, supplement the vector index 135, and/or validate the generated equipment content.

The equipment content response 154 may include a natural language response. For example, a user may interact with the equipment content system 120 through a chat-based interface. In some cases, the generative AI model 117 provides the equipment content response 154 to a client device, such as through one or more other systems or applications. The equipment content response 154 may include tables, charts, and/or images. In some cases, the equipment content response 154 indicates one or more equipment documents responsive to the equipment content request 152. For example, the equipment content response 154 may indicate one or more equipment documents, or excerpts therefrom, which provide support, context, and/or information associated with the equipment content generated by the generative AI model 117.

In some embodiments, the equipment content response 154 includes equipment content generated by the generative AI model 117 based on the generative AI model 117 discovering or finding the equipment content in the equipment documents 132. For example, based on vector embeddings and their corresponding metadata in the vector index 135, the generative AI model 117 may locate a specification of oil and gas equipment, identify a previous quote or price for oil and gas equipment, discover a design of an oil and gas operation, etc. The equipment content response 154 may accordingly be generated to return that (e.g., existing) information to support its generative output predictions in an equipment content response.

In some embodiments, the generative AI model 117 generates new equipment content that is not explicitly or entirely found in the equipment documents 132 but that is otherwise based on information therein. For example, the equipment content request 152 may request a design for an oil and gas system and/or service having certain specifications and requirements. Based on the equipment content request 152, the generative AI model 117 may generate a design for an oil and gas system and/or service that was not previously designed or that was not otherwise indicated in the equipment documents 132. The generative AI model 117 may utilize the embedding space indicated by the vector index 135, and may generate, based on related designs and/or equipment indicated in the equipment documents 132, a design responsive to the specific requirements provided via the equipment content request 152. The generative AI model 117 may generate new equipment content in this way responsive to any type of equipment content request 152 and with respect to any oil and gas domain. In some embodiments, the generative AI model 117 is instructed or constrained to not generate new content that is inaccurate, fanciful, false, or overly imaginative. Rather, the generative AI model 117 generates new content that is relevant to the equipment content requests 152 and is based on and/or supported by the information in the equipment documents 132.

In one particular example, an equipment content request 152 may be associated with generating a bid or quote for providing an oil and gas system and/or service. For instance, the equipment content request 152 may request a quote to provide a midstream production system and service for a particular site, client, production system, etc., having certain specifications, outputs, and other requirements. For instance, the equipment content request may indicate a type and volume of hydrocarbon resource to be processed, as well as an associated location and schedule. The equipment documents 132 may accordingly include equipment information associated with midstream production systems, such as indicating equipment types and specifications, cost and/or historical quotes, inventory and availability, location, and any other information relevant to designing, providing, and/or operating a midstream production system. The equipment content system 120 may extract, segment, and embed the equipment information into an embedding space as described herein and as represented by the vector index 135.

Based on the equipment content request 152, the equipment content system 120 may provide the vector index 135 and an equipment content prompt 156 to the generative AI model 117 to instruct the generative AI model 117 to generate an equipment content response 154 that includes a quote for the indicated midstream production system. For instance, the quote may indicate a cost, price, or bid for providing the midstream production system and service, and the quote may comprise newly generated content by the generative AI model 117 that is not explicitly or completely included in the equipment documents 132. For example, the generated equipment content may be based on information from the equipment documents 132 learned via the vector index 135, but the generated equipment content may indicate one or more quotes, collections of equipment, services, etc., that were not previously indicated in the equipment documents. For instance, the generative AI model may account for sourcing a particular specification of equipment not previously sourced, sourcing equipment to and/or from a location and/or in a manner not previously considered, accounting for variations in currency and/or inflation. Indeed, the generative AI model may generate a response that includes unique, new, or otherwise not previously considered variations for providing midstream production systems and services. By doing so, the equipment content system 120 may leverage the generative AI model to accurately provide and adapt quotes that seamlessly offer a variety of different midstream production services, including services that are new and/or unique in one or more aspects.

In some cases, the equipment content system 120 may save or store the equipment content response 154, to the data storage 130. For instance, the generated content by the generative AI model 117 may be stored such that it may be referenced and/or incorporated into the vector index 135 for use in responding to further equipment content requests 152. Storing previously generated equipment content response 154 may facilitate quickly and efficiently generating equipment content for equipment content request 152 that may be the same as or similar to previous equipment content requests 152.

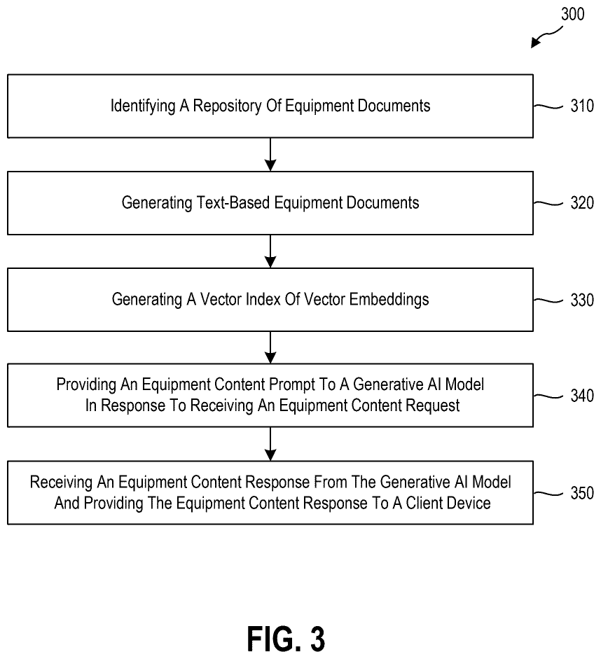

FIG. 3 illustrates a flow diagram for a method 300 or a series of acts for generating equipment content responses using a generative AI model, according to at least one embodiment of the present disclosure. While FIG. 3 illustrates acts according to one embodiment, alternative embodiments may add to, omit, reorder, or modify any of the acts of FIG. 3. In some embodiments, the acts of FIG. 3 are performed as a computer-implemented method. In some embodiments, the acts of FIG. 3 are performed by a computing system. In some embodiments, the acts of FIG. 3 are performed as instructions stored on a computer-readable storage medium.

In some embodiments, the method 300 includes an act 310 of identifying a repository of equipment documents. For example, the act 310 may include identifying a repository of equipment documents in an unstructured format for oil and gas equipment.

In some embodiments, the method 300 includes an act 320 of generating text-based equipment documents. For example, the act 320 may include generating text-based equipment documents based on parsing the equipment documents into a computer-readable text format.

In some embodiments, the method 300 includes an act 330 of generating a vector index of vector embeddings. For example, the act 330 may include generating a vector index of vector embeddings by using an embedding model to create the vector embeddings from the text-based equipment documents.

In some embodiments, the method 300 includes an act 340 of providing an equipment content request to a generative AI model in response to receiving an equipment content request. For example, the act 340 may include, in response to receiving an equipment content request, providing the vector index and an equipment content prompt generated based on the equipment content request to a generative AI model, the equipment content prompt including instructions for the generative AI model to generate an equipment content response using the vector embeddings from the vector index.

In some embodiments, the method 300 includes an act 350 of receiving an equipment content response from the generative AI model and providing the equipment content response to a client device. For example, the act 350 may include, based on receiving the equipment content response from the generative AI model, providing the equipment content response to a client device.

In some embodiments, the method 300 further includes generating the text-based equipment documents based on parsing unstructured text within a first equipment document into text data in a first computer-readable text format associated with parsed text, and creating a first vector embedding from the text data using the embedding model.

In some embodiments, the method 300 further includes generating metadata for the text data based on the unstructured text of the first equipment document, and associating the metadata for the text data with the first vector embedding in the vector index, the metadata including context information of the unstructured text in the first equipment document.

In some embodiments, the context information of the unstructured text identifies a document location of the first equipment document within the repository.

In some embodiments, a second equipment document of the equipment documents includes an unstructured table, and method 300 further includes generating the text-based equipment documents based on parsing the unstructured table in the second equipment document into tabular data in a second computer-readable text format associated with parsed tables, and creating a second vector embedding from the tabular data using the embedding model.

In some embodiments, the method 300 further includes generating metadata for the tabular data from the second equipment document, and associating the metadata for the tabular data with the second vector embedding in the vector index, the metadata including context information for the unstructured table in the second equipment document.

In some embodiments, the context information provides a copy of the tabular data in the second computer-readable text format.

In some embodiments, parsing the unstructured table includes generating a textual description of the unstructured table, and the metadata includes a link to access the unstructured table.

In some embodiments, a third equipment document includes an image and the method 300 further includes generating the text-based equipment documents based on generating an image description of the image in the third equipment document in a third computer-readable text format associated with image descriptions, and creating a third vector embedding from the image data using the embedding model.

In some embodiments, the method 300 further includes: generating metadata for the image data from the third equipment document, and associating the metadata for the image data with the third vector embedding in the vector index, the metadata including context information of the image in the third equipment document.

In some embodiments, the context information identifies text in the third equipment document surrounding the image.

In some embodiments, the method 300 further includes segmenting text of the text-based equipment documents into blocks, wherein the vector embeddings are created based on the blocks.

In some embodiments, segmenting the text into the blocks is based on applying a token allocation to the text-based equipment documents, and the blocks include a token overlap between adjacent text blocks.

In some embodiments, the generative AI model generates the equipment content response by synthesizing content from the vector embeddings within the vector index to generate new equipment content, wherein the new equipment content is not included in the equipment documents.

In some embodiments, the equipment content response includes metadata identifying a set of equipment documents from the repository that supports the new equipment content within the equipment content response.

In some embodiments, the generative AI model is a large language model (LLM). In some embodiments, the method 300 further includes providing the vector index and the equipment content prompt to a large language model (LLM); and receiving, from the LLM, the equipment content response including a natural language response of a quote for providing an oil and gas service or product responsive to the equipment content request.

In some embodiments, generating the equipment content prompt includes: identifying one or more relevant vector embeddings in the vector index that are relevant to a context of the equipment content request; and providing the equipment content prompt and the one or more relevant vector embeddings to the generative AI model to generate the equipment content response based on the equipment content prompt and the one or more relevant vector embeddings.

In some embodiments, one or more of the equipment documents are PDF documents. In some embodiments, one or more of the equipment documents include one or more PDF equipment documents that include vendor quotes for various oil and gas equipment defined by equipment type and equipment specifications and the generative AI model generates the equipment content response based on the vendor quotes as represented by one or more vector embeddings for the one or more PDF equipment documents in the vector index.

In some embodiments, the equipment documents include vendor quotes for various oil and gas equipment defined by equipment type and equipment specifications.

In some embodiments, the method 300 includes identifying a repository of equipment documents in an unstructured format for oil and gas equipment the equipment documents including unstructured text information and unstructured tabular information, generating text-based equipment documents based on parsing the unstructured text information into text data in a computer-readable text format and parsing the unstructured tabular information into tabular data in the computer-readable text format, segmenting text of the text data and of the tabular data into blocks based on applying a token allocation to the text of the blocks and applying a token overlap between adjacent blocks, generating a vector index of vector embeddings by using an embedding model to create the vector embeddings from the blocks, in response to receiving an equipment content request, providing the vector index and an equipment content prompt generated based on the equipment content request to a generative AI model, the equipment content prompt including instructions for the generative AI model to generate an equipment content response using the vector embeddings from the vector index, and based on receiving the equipment content response from the generative AI model, providing the equipment content response to a client device.

Turning now to FIG. 4, this figure illustrates certain components that may be included within a computer system 400. One or more computer systems 400 may be used to implement the various devices, components, and systems described herein.

The computer system 400 includes a processor 401. The processor 401 may be a general-purpose single-or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 401 may be referred to as a central processing unit (CPU). Although just a single processor 401 is shown in the computer system 400 of FIG. 4, in an alternative configuration, a combination of processors (e.g., an ARM and DSP) could be used.

The computer system 400 also includes memory 403 in electronic communication with the processor 401. The memory 403 may include computer-readable storage media and can be any available media that can be accessed by a general purpose or special purpose computer system. Computer-readable media that store computer-executable instructions are non-transitory computer-readable media (device). Computer-readable media that carry computer-executable instructions are transmission media. Thus, by way of example and not limitations, embodiment of the present disclosure can comprise at least two distinctly different kinds of computer-readable media: non-transitory computer-readable media (devices) and transmission media.

Both non-transitory computer-readable media (devices) and transmission media may be used temporarily to store or carry software instructions in the form of computer readable program code that allows performance of embodiments of the present disclosure. Non-transitory computer-readable media may further be used to persistently or permanently store such software instructions. Examples of non-transitory computer-readable storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored or in software, hardware, firmware, or combinations thereof.

Instructions 405 and data 407 may be stored in the memory 403. The instructions 405 may be executable by the processor 401 to implement some or all of the functionality disclosed herein. Executing the instructions 405 may involve the use of the data 407 that is stored in the memory 403. Any of the various examples of modules and components described herein may be implemented, partially or wholly, as instructions 405 stored in memory 403 and executed by the processor 401. Any of the various examples of data described herein may be among the data 407 that is stored in memory 403 and used during execution of the instructions 405 by the processor 401.

A computer system 400 may also include one or more communication interfaces 409 for communicating with other electronic devices. The communication interface(s) 409 may be based on wired communication technology, wireless communication technology, or both. Some examples of communication interfaces 409 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The communication interfaces 409 may connect the computer system 400 to a network. A “network” or “communications network” may generally be defined as one or more data links that enable the transport of electronic data between computer systems and/or modules, engines, or other electronic devices, or combinations thereof. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instruction or data structures and which can be accessed by a general purpose or special purpose computer.

A computer system 400 may also include one or more input devices 411 and one or more output devices 413. Some examples of input devices 411 include a keyboard, mouse, microphone, remote control device, button, joystick, trackball, touchpad, and lightpen. Some examples of output devices 413 include a speaker and a printer. One specific type of output device that is typically included in a computer system 400 is a display device 415. Display devices 415 used with embodiments disclosed herein may utilize any suitable image projection technology, such as liquid crystal display (LCD), light-emitting diode (LED), gas plasma, electroluminescence, or the like. A display controller 417 may also be provided, for converting data 407 stored in the memory 403 into one or more of text, graphics, or moving images (as appropriate) shown on the display device 415.

The various components of the computer system 400 may be coupled together by one or more buses, which may include one or more of a power bus, a control signal bus, a status signal bus, a data bus, other similar components, or combinations thereof. For the sake of clarity, the various buses are illustrated in FIG. 4 as a bus system 419.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Further, upon reaching various computer system components, program code in the form of computer-executable instructions or data structures can be transferred automatically or manually from transmission media to non-transitory computer-readable storage media (or vice versa). For example, computer-executable instructions or data structures received over a network or data link can be buffered in memory (e.g., RAM) within a network interface module (NIC), and then eventually transferred to computer system RAM and/or to less volatile non-transitory computer-readable storage media at a computer system. Thus, it should be understood that non-transitory computer-readable storage media can be included in computer system components that also (or even primarily) utilize transmission media.

The following description from paragraphs [0108]-[0126] includes various embodiments that, where feasible, may be combined in any permutation. For example, the embodiment of paragraph [8 may be combined with any or all embodiments of the following paragraphs. Embodiments that describe acts of a method may be combined with embodiments that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”

In some embodiments, a computer-implemented method for generating equipment content responses using a generative artificial intelligence (AI) model, includes identifying a repository of equipment documents in an unstructured format for oil and gas equipment, generating text-based equipment documents based on parsing the equipment documents into a computer-readable text format, generating a vector index of vector embeddings by using an embedding model to create the vector embeddings from the text-based equipment documents, in response to receiving an equipment content request, providing the vector index and an equipment content prompt generated based on the equipment content request to a generative AI model, the equipment content prompt including instructions for the generative AI model to generate an equipment content response using the vector embeddings from the vector index, and based on receiving the equipment content response from the generative AI model, providing the equipment content response to a client device.

In some embodiments, the method further includes generating the text-based equipment documents based on parsing unstructured text within a first equipment document into text data in a first computer-readable text format associated with parsed text, and creating a first vector embedding from the text data using the embedding model.

In some embodiments, the method further includes generating metadata for the text data based on the unstructured text of the first equipment document, and associating the metadata for the text data with the first vector embedding in the vector index, the metadata including context information of the unstructured text in the first equipment document.

In some embodiments, the context information of the unstructured text identifies a document location of the first equipment document within the repository.

In some embodiments, a second equipment document of the equipment documents includes an unstructured table, and method further includes generating the text-based equipment documents based on parsing the unstructured table in the second equipment document into tabular data in a second computer-readable text format associated with parsed tables, and creating a second vector embedding from the tabular data using the embedding model.

In some embodiments, the method further includes generating metadata for the tabular data from the second equipment document, and associating the metadata for the tabular data with the second vector embedding in the vector index, the metadata including context information for the unstructured table in the second equipment document.

In some embodiments, the context information provides a copy of the tabular data in the second computer-readable text format.

In some embodiments, parsing the unstructured table includes generating a textual description of the unstructured table, and the metadata includes a link to access the unstructured table.

In some embodiments, a third equipment document includes an image and the method 300 further includes generating the text-based equipment documents based on generating an image description of the image in the third equipment document in a third computer-readable text format associated with image descriptions, and creating a third vector embedding from the image data using the embedding model.

In some embodiments, the method further includes: generating metadata for the image data from the third equipment document, and associating the metadata for the image data with the third vector embedding in the vector index, the metadata including context information of the image in the third equipment document.

In some embodiments, the context information identifies text in the third equipment document surrounding the image.

In some embodiments, the method further includes segmenting text of the text-based equipment documents into blocks, wherein the vector embeddings are created based on the blocks.

In some embodiments, segmenting the text into the blocks is based on applying a token allocation to the text-based equipment documents, and the blocks include a token overlap between adjacent text blocks.

In some embodiments, the generative AI model generates the equipment content response by synthesizing content from the vector embeddings within the vector index to generate new equipment content, wherein the new equipment content is not included in the equipment documents.

In some embodiments, the equipment content response includes metadata identifying a set of equipment documents from the repository that supports the new equipment content within the equipment content response.

In some embodiments, the generative AI model is a large language model (LLM).

In some embodiments, one or more of the equipment documents are PDF documents.

In some embodiments, a system includes at least one processor, memory in electronic communication with the at least one processor, and instructions stored in the memory, the instructions being executable by the at least one processor to identify a repository of equipment documents in an unstructured format for oil and gas equipment the equipment documents including unstructured text information and unstructured tabular information, generate text-based equipment documents based on parsing the unstructured text information into text data in a computer-readable text format and parsing the unstructured tabular information into tabular data in the computer-readable text format, segment text of the text data and of the tabular data into blocks based on applying a token allocation to the text of the blocks and applying a token overlap between adjacent blocks, generate a vector index of vector embeddings by using an embedding model to create the vector embeddings from the blocks, in response to receiving an equipment content request, provide the vector index and an equipment content prompt generated based on the equipment content request to a generative AI model, the equipment content prompt including instructions for the generative AI model to generate an equipment content response using the vector embeddings from the vector index, and based on receiving the equipment content response from the generative AI model, provide the equipment content response to a client device.

In some embodiments, a computer-readable storage medium including instruction that, when executed by a processor, cause the processor to identify a repository of equipment documents in an unstructured format for oil and gas equipment, generate text-based equipment documents based on parsing the equipment documents into a computer-readable text format, generate a vector index of vector embeddings by using an embedding model to create vector embeddings from the text-based equipment documents, in response to receiving an equipment content request, provide the vector index and an equipment content prompt generated based on the equipment content request to a generative AI model, the equipment content prompt including instructions for the generative AI model to generate an equipment content response using the vector embeddings from the vector index, and based on receiving the equipment content response from the generative AI model, provide the equipment content response to a client device.

The embodiments of the equipment content system have been primarily described with reference to wellbore drilling operations; the equipment content system described herein may be used in applications other than the drilling of a wellbore. In other embodiments, the equipment content system according to the present disclosure may be used outside a wellbore or other downhole environment used for the exploration or production of natural resources. For instance, the equipment content system of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers'specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Additionally, as used herein, the term “and/or” includes any and all combinations of one or more of the associated listed items.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for generating equipment content responses using a generative artificial intelligence (AI) model, comprising:
identifying a repository including equipment documents in an unstructured format for oil and gas equipment;
generating text-based equipment documents based on parsing the equipment documents into a computer-readable text format;
generating a vector index of vector embeddings by using an embedding model to create the vector embeddings from the text-based equipment documents;
in response to receiving an equipment content request, providing the vector index and an equipment content prompt generated based on the equipment content request to a generative AI model, the equipment content prompt including instructions for the generative AI model to generate an equipment content response using the vector embeddings from the vector index; and
based on receiving the equipment content response from the generative AI model, providing the equipment content response to a client device.

2. The method of claim 1, further comprising:
generating the text-based equipment documents based on parsing unstructured text within a first equipment document into text data in a first computer-readable text format associated with parsed text; and
creating a first vector embedding from the text data using the embedding model.

3. The method of claim 2, further comprising:
generating metadata for the text data based on the unstructured text of the first equipment document; and
associating the metadata for the text data with the first vector embedding in the vector index, the metadata including context information of the unstructured text in the first equipment document.

4. The method of claim 3, wherein the context information of the unstructured text identifies a document location of the first equipment document within the repository.

5. The method of claim 1, wherein a second equipment document of the equipment documents includes an unstructured table, the method further comprising:
generating the text-based equipment documents based on parsing the unstructured table in the second equipment document into tabular data in a second computer-readable text format associated with parsed tables; and
creating a second vector embedding from the tabular data using the embedding model.

6. The method of claim 5, further comprising:
generating metadata for the tabular data from the second equipment document; and
associating the metadata for the tabular data with the second vector embedding in the vector index, the metadata including context information for the unstructured table in the second equipment document.

7. The method of claim 6, wherein the context information provides a copy of the tabular data in the second computer-readable text format.

8. The method of claim 7, wherein:
parsing the unstructured table includes generating a textual description of the unstructured table; and
the metadata includes a link to access the unstructured table.

9. The method of claim 1, wherein a third equipment document includes an image, the method further comprising:
generating the text-based equipment documents based on generating an image description of the image in the third equipment document in a third computer-readable text format associated with image descriptions; and
creating a third vector embedding from the image description using the embedding model.

10. The method of claim 9, further comprising:
generating metadata for the image description from the third equipment document; and
associating the metadata for the image description with the third vector embedding in the vector index, the metadata including context information of the image in the third equipment document.

11. The method of claim 10, wherein the context information identifies text in the third equipment document surrounding the image.

12. The method of claim 1, further comprising segmenting text of the text-based equipment documents into blocks, wherein the vector embeddings are created based on the blocks.

13. The method of claim 12, wherein:
segmenting the text into the blocks is based on applying a token allocation to the text-based equipment documents; and
the blocks include a token overlap between adjacent text blocks.

14. The method of claim 1, wherein the generative AI model generates the equipment content response by synthesizing content from the vector embeddings within the vector index to generate new equipment content supported by content in the equipment documents, wherein the new equipment content is not included in the equipment documents.

15. The method of claim 14, wherein the equipment content response includes metadata identifying a set of equipment documents from the repository that supports the new equipment content within the equipment content response.

16. The method of claim 1, further comprising:
providing the vector index and the equipment content prompt to a large language model (LLM); and
receiving, from the LLM, the equipment content response including a natural language response of a quote for providing an oil and gas service or product responsive to the equipment content request.

17. The method of claim 1, wherein generating the equipment content prompt includes:
identifying one or more relevant vector embeddings in the vector index that are relevant to a context of the equipment content request; and
providing the equipment content prompt and the one or more relevant vector embeddings to the generative AI model to generate the equipment content response based on the equipment content prompt and the one or more relevant vector embeddings.

18. The method of claim 1, wherein:
one or more of the equipment documents include one or more PDF equipment documents that include vendor quotes for various oil and gas equipment defined by equipment type and equipment specifications; and
the generative AI model generates the equipment content response based on the vendor quotes as represented by one or more vector embeddings for the one or more PDF equipment documents in the vector index.

19. A system, comprising:
at least one processor;
memory in electronic communication with the at least one processor; and
instructions stored in the memory, the instructions being executable by the at least one processor to:
identify a repository including equipment documents in an unstructured format for oil and gas equipment, the equipment documents including unstructured text information and unstructured table information;
generate text-based equipment documents based on parsing the unstructured text information into text data in a first computer-readable text format;
parse the unstructured table information into tabular data in a second computer-readable text format;
segment text of the text data and of the tabular data into blocks based on applying a token allocation to the text of the blocks that implements a token overlap between adjacent blocks;
generate a vector index of vector embeddings by using an embedding model to create the vector embeddings from the blocks;
in response to receiving an equipment content request, provide the vector index and an equipment content prompt generated based on the equipment content request to a generative AI model, the equipment content prompt including instructions for the generative AI model to generate an equipment content response using the vector embeddings from the vector index; and
based on receiving the equipment content response from the generative AI model, provide the equipment content response to a client device.

20. A non-transitory computer-readable storage medium including instruction that, when executed by a processor, cause the processor to:
identify a repository including equipment documents in an unstructured format for oil and gas equipment;
generate text-based equipment documents based on parsing the equipment documents into a computer-readable text format;
generate a vector index of vector embeddings by using an embedding model to create vector embeddings from the text-based equipment documents;
in response to receiving an equipment content request, provide the vector index and an equipment content prompt generated based on the equipment content request to a generative AI model, the equipment content prompt including instructions for the generative AI model to generate an equipment content response using the vector embeddings from the vector index; and
based on receiving the equipment content response from the generative AI model, provide the equipment content response to a client device.
